(19) United States
(12) Patent Application Publication
(10) Pub. No.: US 2014/0370265 A1
(43) Pub. Date: Dec. 18, 2014

(54) COMPOSITION FOR PREPARING A BONDING MATERIAL AND USES THEREOF

(71) Applicant: 3M INNOVATIVE PROPERTIES COMPANY, St Paul, MN (US)

(72) Inventors: Justina S. Lee, Singapore (SG); Hyung-Jin Song, Seoul (KR); Andrew J. Ouderkirk, St. Paul, MN (US); David J. Plaut, St. Paul, MN (US)

(21) Appl. No.: 14/345,100

(22) PCT Filed: Sep. 12, 2012
(86) PCT No.: PCT/US2012/054896

§ 371 Date: Mar. 14, 2014

Related U.S. Application Data
(60) Provisional application No. 61/536,849, filed on Sep. 20, 2011.

(51) Int. Cl. C09J 7/02; C09J 163/00; C09J 133/14; B32B 7/12; B32B 33/00

(52) U.S. Cl. CPC C09J 7/0242; B32B 7/12; B32B 33/00; C09J 133/14; C09J 163/00; C09J 7/026; C09J 7/0264; C09J 7/0292; B32B 2250/02; B32B 2255/26; B32B 2405/00; B32B 2457/08; C09J 2433/00; C09J 2463/00; C09J 2203/326; C09J 2201/122
USPC 428/220; 428/414; 428/355 EP; 428/344; 525/107; 522/111

(57) ABSTRACT

The present invention discloses a composition for preparing a bonding material for use in a circuit board comprising a polymerizable acrylate system and a curable epoxy resin system, the composition being photocurable. The present invention also provides a circuit board comprising the bonding material.

### TECHNICAL FIELD

The present invention relates to a composition for preparing a bonding material for use in a circuit board. The present invention also relates to a circuit board comprising the bonding material.

### BACKGROUND

Bonding material or adhesives which are thermally conductive and electrically insulating are commonly known in the art. In particular, photocured adhesives are widely used as a fast curing adhesive with wavelength between 200-700 nm exposures. This covers the full spectrum of both ultraviolet light as well as visible light. The advantages of using photocured adhesives is that the adhesives are able to cure relatively quickly at room temperature, able to cure on demand and require less equipment set-up in preparing the adhesives. The preparation of photocured adhesives also consume less energy compared to a thermally cured adhesive. However, one of the drawbacks of photocured adhesives is that the depth of light penetration for polymerization may be affected when the adhesive is loaded with fillers for enhancing material properties. Fillers are usually added to the material used in the formation of the adhesive because the fillers result in a higher thermal tolerance of the material. However, the fillers tend to increase the opacity of the adhesive and consequently, the adhesive may not be able to achieve full cure upon exposure of light as the thickness of the adhesive would not allow light to fully penetrate through the adhesive material.

Thermally cured adhesives are also commonly used. However, the disadvantage of such adhesives is that they require a long curing time thereby increasing processing time to prepare the adhesives and as mentioned above, result in the consumption of more energy.

### SUMMARY

The present invention seeks to address these problems, and provides an improved composition for preparing a bonding material, and a circuit board comprising a bonding material.

According to a first aspect, the present invention provides a circuit board comprising a first layer and a second layer of an impermeable material and a third layer of a bonding material, the bonding material comprising a polymerized polymer and a cured epoxy, wherein the first layer and the second layer are bonded to each other with the third layer, and wherein the bonding material has a sufficiently high viscosity such that the third layer does not exhibit substantial flow when heated to between 50° C. and 288° C.

The polymerized polymer comprised in the bonding material may be any suitable polymer. For example, the polymer may be an acrylate. In particular, the polymer may be urethane acrylate.

The cured epoxy comprised in the bonding material may be any suitable epoxy. For example, the epoxy may be a multifunctional epoxy. In particular, the epoxy may be, but not limited to, cresol novolac or phenol novolac epoxy.

According to a particular aspect, the bonding material may have a viscosity of 10-106 Pa/s when heated to between 50° C. and 288° C.

According to another particular aspect, the bonding material may have a thermal resistance of 0.1-3° C.-cm2/W.

The peel adhesion strength of the bonding material may be at least 0.5 Kgf.

The bonding material may have a tensile shear stress of at least 1500 psi. In particular, the tensile shear stress may be in the range of 1500-2850 psi, 1700-2800 psi, 1800-2600 psi, 2000-2550 psi.

According to a second aspect, the present invention provides a composition for preparing a bonding material for use in a circuit board for bonding to a first layer and a second layer of an impermeable material, the bonding material comprising:

a polymerizable acrylate system; and

a curable epoxy resin system,

wherein the composition is photocurable to enable the acrylate system to polymerize without curing the epoxy resin system.

According to a particular aspect, the composition may comprise 10-80% by weight of a polymerizable acrylate system and 20-80% by weight of a curable epoxy resin system.

According to another particular aspect, the composition may further comprise a photoinitiator, thermally conductive filler, or a combination thereof. According to a particular aspect, the composition may comprise 0.01-5% by weight of a photoinitiator. According to another particular aspect, the composition may comprise 70% by weight of thermally conductive filler.

According to a particular aspect, the composition may be thermally curable to enable the epoxy resin system to cross-link. The composition may therefore further comprise a thermal initiator. The composition may comprise 2-5% by weight of a thermal initiator.

According to a particular aspect, a tape, comprises a composition for bonding to at least a first layer, comprising a polymerizable acrylate system and a curable epoxy resin system, wherein the composition is photocurable to enable the acrylate system to polymerize without curing the epoxy resin system. In another aspect, the tape further comprises a backing layer disposed on at least one side of the composition. In another aspect, the backing layer comprises at least one of a glass, a polymer, a ceramic, and a metal. In another aspect, the composition has a thickness of about 6 μm to about 300 μm or a thickness of about 12 μm to about 200 μm. In another aspect, wherein the composition has a thickness and an opacity such that, when exposed to curing radiation, a center of the composition receives at least 10%, at least 25%, or at least 50% of the curing radiation flux as compared to a surface directly exposed to the curing radiation.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1 shows a process flow of a method for preparing a bonding material according to a particular embodiment of the present invention;

FIG. 2 shows a cross-sectional view according to a particular embodiment of a circuit board of the present invention;

FIG. 3 shows the arrangement of apparatus set up for an overlap shear strength test;

FIG. 4 shows the load (lbf) vs extension (inches) graphs for samples (1) to (3) (FIG. 4A) and for sample (4) (FIG. 4B). The samples are described in the Example; and

FIG. 5 shows a cross section view of a tape embodiment according to another aspect of the invention.

### DETAILED DESCRIPTION

The present invention provides a circuit board and a composition for preparing a bonding material for use in a circuit board. The circuit board may be for use in LED applications. In particular, the circuit board may be for use during the fabrication of LEDs. The circuit board comprises a bonding material which does not exhibit substantial flow when heated between the working temperatures of the circuit board.

The composition may be for preparing a bonding material for use in a circuit board for bonding to a first layer and a second layer of an impermeable material. The composition comprises:

a polymerizable acrylate system; and

a curable epoxy resin system,

wherein the composition is photocurable to enable the acrylate system to polymerize without curing the epoxy resin system. The composition can be applied in liquid form or, alternatively, the composition can be part of a tape.

### Polymerizable Acrylate System

The polymerizable acrylate system may comprise at least one acrylate. Any suitable polymerizable acrylate may be comprised in the acrylate system. The polymerizable acrylate system may comprise at least one or more of a monofunctional and/or a difunctional acrylate, or a combination of polyfunctional acrylates. For example, the acrylate may be, but not limited to, 2-phenoxyethyl acrylate ester, ethoxylated bisphenol A diacrylate ester, butyl(meth)acrylate, hexyl(meth)acrylate, 2-ethylhexyl(meth)acrylate, octyl(meth)acrylate, isooctyl(meth)acrylate, decyl(meth)acrylate or dodecyl(meth)acrylate.

The polymerizable acrylate system may be present in the composition in an amount in a range of 10-80% by weight, based on the total weight of the composition. In particular, the polymerizable acrylate system may be present in an amount of 10-50%, 10-30%, 10-20% by weight. Even more in particular, the polymerizable acrylate system may be present in an amount 15.39% by weight. In this way, a balance between including a suitable amount of polymerizable acrylate to obtain a suitable bonding material and including other components to obtain improved adhesive properties of the bonding material may be achieved. For example, the acrylate system may comprise 11.57% by weight of 2-phenoxyethyl acrylate ester and 3.82% by weight of ethoxylated bisphenol A diacrylate ester.

### Curable Epoxy Resin System

The curable epoxy resin system may be a cross-linkable epoxy resin system. The curable epoxy resin system may comprise at least one suitable epoxy resin. The epoxy resin system may be any organic or inorganic system with epoxy functionality. The epoxy resin system may comprise a multifunctional epoxy. The epoxy resin system may be an aromatic epoxy resin, a cycloaliphatic epoxy resin, an aliphatic epoxy resin, or a mixture of two or more thereof. For example, the epoxy resin system may include epoxy resins which may be produced by reaction of a hydroxyl, carboxyl or amine-containing compound with epichlorohydrin in the presence of a basic catalyst, such as metal hydroxide. In particular, the epoxy may be, but not limited to, epichlorohydrin formaldehyde-phenol polymer epoxy resin and chelated modified epoxy. Examples of commercial sources of epoxies include EP-49-23 (Adeka), EP-49-10 (Adeka) EP4085 (Adeka), Epiclon resins from the N-7xx (DIC Corporation), N-8xx (DIC Corporation) or N-6xx (DIC Corporation) series, Epon 164 (Momentive) or Epikote resin 678 (Momentive).

The curable epoxy may be present in the composition in an amount in a range of 20-80% by weight, based on the total weight of the composition. In particular, the curable epoxy system may be present in an amount of 30-50% or 40-50% by weight. Even more in particular, the curable epoxy system may be present in an amount 46.69% by weight. In this way, the epoxy performance may be fully maximised to obtain a suitable bonding material and the composition may be B-staged into a suitable bonding material. According to a particular aspect, the composition may comprise 43.85% by weight of epichlorohydrin formaldehyde-phenol polymer epoxy (Epiclon N-740 (DIC Corporation)) and 2.23% by weight of phenol-,4.4′-(1-methylethylidene) (PKHP-200 (Inchem)).

### Method of Preparing the Composition

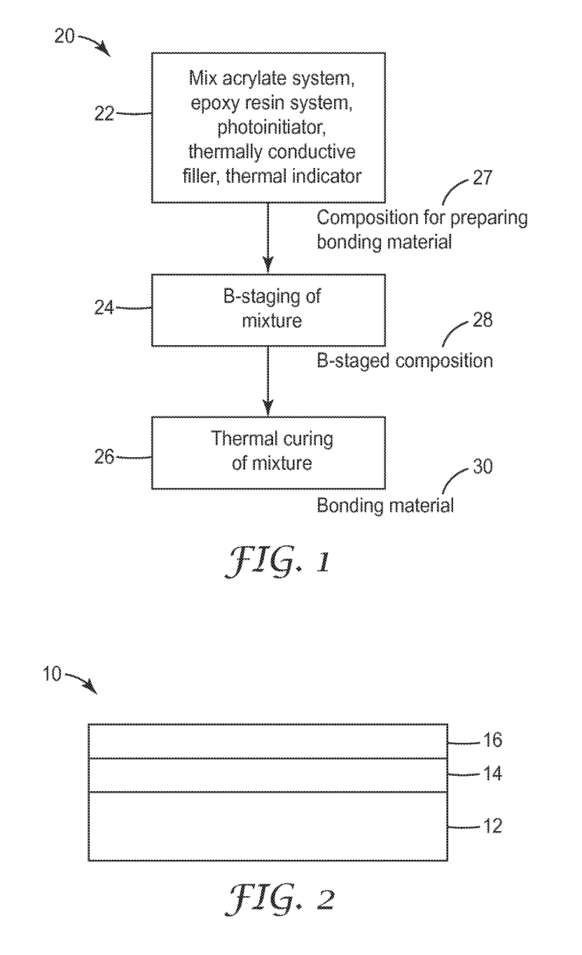

The method of preparing the composition will now be described in more detail. The method 20 is shown in FIG. 1.

The composition 27 is prepared according to step 22. In particular, the different components of the composition 27 are mixed together. As described above, the composition 27 comprises a polymerizable acrylate system and a curable epoxy resin system. The composition 27 may comprise 10-80% by weight of the polymerizable acrylate system and 20-80% by weight of the curable epoxy resin system. In particular, the composition 27 may comprise about 15.39% of the polymerizable acrylate system and about 46.69% of the curable epoxy resin system.

The composition may optionally comprise further components. These optional further components may be mixed with the polymerizable acrylate system and the curable epoxy resin system in step 22 to prepare the composition 27.

For example, the composition 27 may comprise a suitable reactive or non-reactive epoxy diluent. The epoxy diluent may reduce the viscosity of the epoxy resin comprised in the epoxy resin system to make it easier to compound with fillers or improve filler loading capacity. Further, a lower viscosity is important in achieving good adhesion.

The epoxy diluent may be, but is not limited to, glycidyl ether of cashew nutshell liquid (2513HP (Cardolite)) or N,N-diglycidyl-4-glycidyloxyaniline (ERL 0510 triglycidyl-p-aminophenol).

The composition 27 may comprise a suitable amount of the epoxy diluent. For example, the composition 27 may comprise 1-5% by weight of epoxy diluent based on the total weight of the composition. In particular, the composition 27 may comprise 1.5-3.5% by weight of epoxy diluent. According to a particular aspect, the composition 27 may comprise about 2.84% by weight of glycidyl ether of cashew nutshell liquid (2513HP (Cardolite)).

The composition 27 may comprise any suitable photoinitiator and thermal initiator. For example, the composition 27 may comprise a suitable photoinitiator if the composition 27 is to be stored at room temperature and a long shelf-life is desired. The photoinitiator may promote polymerization of the polymerizable acrylate system. In particular, when the photoinitiator is exposed to a particular wavelength of light suitable for that particular photoinitiator, the photoinitiator decomposes into free radicals and promotes polymerization of the acrylate system.

The photoinitiator may be a UV photoinitiator or cationic photoinitiator. For example, the photoinitiator may be, but not limited to, 2-benzyl-2-(dimethylamino)-1-(4-(4-morpholinyl)phenyl)-1-butanone or 4-methylphenyl [4-(1-methylethyl)phenyl]iodonium tetrakis(pentafluorophenyl)borate, 2,4,6-trimethylbenzoyl-diphenyl-phosphineoxide, phosphineoxide phenylbis-(2,4,6-triemthyl benzoyl), or a combination thereof. In particular, the photoinitiator may be 2-benzyl-2-(dimethylamino)-1-(4-(4-morpholinyl)phenyl)-1-butanone.

The thermal initiator may be an organic peroxide. In particular, the thermal initiator may be cumene peroxide, tert-butyl hydroperoxide, or a combination thereof.

The composition 27 may comprise a suitable amount of the photoinitiator. According to a particular aspect, the composition 27 may comprise 0.01-5% by weight of a photoinitiator based on the total weight of the composition. For example, the composition 27 may comprise 0.1-1.5% or 0.5-1.0% by weight. According to a particular aspect, the composition 27 may comprise 0.35% by weight of 2-benzyl-2-(dimethylamino)-1-(4-(4-morpholinyl)phenyl)-1-butanone.

The composition 27 may further comprise a photoinitiator adjuvant, a photosensitizer and a chain transfer agent in order to promote the radiation polymerization. Any suitable photoinitiator adjuvant may be used. For example, the photoinitiator adjuvant may be an iodonium borate salt, such as Rhodorsil 2074 (Rhodia). Any suitable photosensitizer may be used. For example, the photosensitizer may be isopropylthioxanthone (ITX) or camphorquinone (CPQ). Any suitable chain transfer agent may be used. For example, the chain transfer agent may be ethyl p-dimethylamino benzoate (EDMAB).

The composition 27 may comprise any suitable filler. The filler may be a thermally conductive filler and/or an insulating filler. The filler may be able to conduct heat across an air gap in enclosures with restricted convection and insufficient room for conventional heat sinks. For example, the filler may be, but not limited to, aluminium oxide, aluminium nitride, aluminium hydroxide, boron nitride, diamond or graphene. The filler may be a thermally conductive filler which may include metal particles and/or carbon particles.

The composition 27 may comprise a suitable amount of filler. For example, the composition 27 may comprise 70% by weight of filler based on the total weight of the composition. In particular, the composition 27 may comprise 10-60% or 25-50% by weight of filler based on the total weight of the composition. In this way, a balance between the thermal conductivity and adhesive performance of the bonding material may be achieved. In particular, a higher weight content of filler would increase the thermal conductivity but would adversely affect the adhesive property of the bonding material. According to a particular aspect, the composition 27 may comprise 29.41% by weight of aluminium oxide.

The composition 27 may also comprise a suitable coupling agent. The coupling agent may be a cross-linking agent. The coupling agent assists in promoting better adhesion strength when the bonding material prepared from the composition 27 is applied on a substrate.

The coupling agent may be a silane coupling agent, a Schiff base (azomethine), a chelated compound or a benzotriazol. For example, the coupling agent may be, but not limited to, 3-glycidoxypropyl trimethoxysilane or bis-salicylinen-1,2-propanediamine.

The composition 27 may comprise a suitable amount of coupling agent. The composition 27 may comprise 0.1-1.5% by weight of coupling agent based on the total weight of the composition 27. In particular, the composition 27 may comprise 0.3-0.8% by weight of coupling agent. According to a particular aspect, the composition 27 may comprise 0.47% by weight of 3-glycidoxypropyl trimethoxysilane.

The composition 27 may comprise any suitable curing agent. The curing agent may be added to the composition 27 to promote the curing reaction of the curable epoxy resin system.

The curing agent may be a latent thermal curing agent. For example, the curing agent may be an imidazole, modified polyamine, hydrazine or its derivatives, dicyandiamine or its derivatives, or any other latent catalyst suitable for epoxy adhesives. The thermal curing agent may enable the epoxy resin system to thermally cure. In particular, the thermal curing agent may enable the epoxy resin system to cross-link, thereby fully curing the composition to form a polymer. The curing agent may be, but not limited to, 2,4-diamino-6-[2′-methylimidazolyl-(1′)]-ethyl-s-triazine or 7,11-octadecadiene-1,18-dicarbohydrazide.

A suitable amount of the curing agent may be comprised in the composition 27. The composition 27 may comprise 2-10% by weight of curing agent based on the total weight of the composition. In particular, the composition 27 may comprise 2-5% by weight of the curing agent. According to a particular aspect, the composition 27 may comprise 2.52% by weight of 2,4-diamino-6-[2′-methylimidazolyl-(1′)]-ethyl-s-triazine. In particular, the composition 27 may comprise micronized powder of 2,4-diamino-6-[2′-methylimidazolyl-(1′)]-ethyl-s-triazine.

Once the composition 27 is prepared, the composition 27 is subjected to a step 24 of B-staging to form a B-staged composition 28. During the step 24, the composition 27 is subjected to exposure of UV light thereby allowing the acrylate system comprised in the composition 27 to polymerize by photocuring. In particular, the composition 27 is exposed to UV light from a UV curing bulb with a UV-A dosage of 500-3500 mJ/cm2 to form the B-staged composition 28. In the B-staged composition 28, the acrylate system of the composition 27 is polymerized while the epoxy resin system remains in an uncured state. In this way, the B-staged composition 28 has a suitable level of tackiness to adhere to a substrate.

The B-staged composition 28 may be applied to a suitable substrate. For example, the B-staged composition 28 may be applied to a circuit board. The circuit board may be as described below.

The B-staged composition 28 may then be subjected to a further step 26 of thermal curing to form a bonding material 30. The step 26 enables the curing of the epoxy resin system. In particular, the step 26 enables the epoxy resin system to cross-link to form a fully cured material. In particular, the step 26 involves thermally curing the B-staged composition 28 for a period of from 2-60 minutes at a temperature of 150-220° C.

By separating the steps 24 and 26, the composition 27 may be more completely cured. In particular, if the UV light is not able to fully penetrate through the acrylate system during the step 24 due to the presence of fillers or due to the thickness of the composition 27, this may result in incomplete polymerization of the acrylate system. However, the subsequent curing or cross-linking of the epoxy resin system at the step 26 enables the composition 27 to become fully cured to form a bonding material 30. Further, the bonding material 30 prepared from the method of the present invention is in a paste or liquid form. The bonding material 30 is therefore easier to apply and to further process the bonding material 30 during application. The method avoids the need for a die cut which would be required in a film-based adhesive.

### Application as a Circuit Board

FIG. 2 shows a circuit board 10, comprising a first layer 12 of a first impermeable material, a second layer 16 of a second impermeable material, and a third layer 14 of a bonding material. The first layer 12 and the second layer 16 are each bonded with the third layer 14.

The circuit board 10 may be any suitable circuit board for the purposes of the present invention. For example, the circuit board 10 may be for use in LED application.

The first layer 12 and the second layer 16 may be formed of the same or different impermeable material. The impermeable material of the first layer 12 and the second layer 16 may be any suitable material. For example, the impermeable material may be any suitable heat-conducting material. In particular, the impermeable material may be, but not limited to, aluminium, aluminized steel or copper. Even more in particular, the impermeable material of the first layer 12 may be aluminium and the impermeable material of the second layer 16 may be copper.

The bonding material may be as described above. In particular, the bonding material does not exhibit substantial flow when heated to between 50° C. and 288° C. Whether or not the third layer 14 exhibits substantial flow relates to the viscosity of the third layer 14. Accordingly, in order for the third layer 14 not to exhibit substantial flow, the viscosity of the bonding material has to be sufficiently high. According to a particular aspect, the bonding material may have a viscosity of 10-106 Pa/s when heated to between 50° C. and 288° C. Even more in particular, the viscosity of the bonding material may be 1000-105 Pa/s when heated to between 50° C. and 288° C. At this range of viscosity, the bonding material provides good bonding performance to laminates.

The bonding material may have a thermal resistance of 0.1-3° C.-cm2/W. Thermal resistance is defined as the resistance of the bonding material to the conduction of thermal energy or heat. As the bonding material is used in the circuit board 10, it would be understood by a person skilled in the art that a lower thermal resistance is desired. The thermal resistance of the bonding material may be 0.2-3 or 0.2-0.6° C.-cm2/W.

The peel adhesion strength of the bonding material may be at least 0.5 Kgf. The peel adhesion strength is defined as the bond strength between the bonding material of the third layer 14 and the first layer 12 or second layer 16. It would be understood by a person skilled in the art that the higher the peel adhesion strength, the more advantageous the bonding material as it would prevent dislodgement of the bonding material from the first layer and the second layer. The peel adhesion strength may be measured by any suitable method known in the art.

The bonding material may have a tensile shear stress of ≧1500 psi. In particular, the tensile shear stress may be in the range of 1500-2600 psi, 1600-2500 psi, 1800-2400 psi. Even more in particular, the tensile shear stress may be about 2600 psi. For the purposes of the present invention, tensile shear stress is defined as the internal force in the bonding material which is caused by an external force acting perpendicular to the bonding material.

In an alternative aspect of the invention, the bonding material can be utilized in tape form. For example, FIG. 5 shows a compositional cross-section of a tape 100 formed from a composition including a b-staged resin and a thermally conductive particulate, such as those described above. The tape may be made by conventional coating methods, with the composition being either applied to and removed from a release surface or being cast onto a removable liner, or a backing that would remain attached to the composition.

The composition can be b-staged by radiation curing from one or both sides. Suitable radiation includes visible light, ultraviolet light, and electron beams. Preferably, the combination of thickness and opacity is such that the center of the tape receives at least 10% of the radiation flux compared to the surface, more preferably, at least 25%, and most preferably, at least 50%.

As shown in FIG. 5, tape 100 has composition uniformity throughout the thickness of the tape. In one aspect, tape 100 can have a thickness of about 6 μm to about 300 μm. In a further aspect, tape 100 can have a thickness of about 12 μm to about 200 μm. While tape 100 does not include a backing layer, in alternative aspects of the invention, tape 100 can include one or more backing layers. Suitable backings include glass, polymers, ceramics, and metals.

Having now generally described the invention, the same will be more readily understood through reference to the following examples which are provided by way of illustration, and are not intended to be limiting.

### EXAMPLES

(a) Compositions

Three different compositions were prepared. The components of each of the compositions and their corresponding amounts comprised in the composition are provided in Table 1.

(b) Tests conducted on composition

### Differential Scanning Calorimetry (DSC)

DSC was performed to measure the exothermic heat of reaction associated with the thermally activated curable monomer after each of the three compositions are fully cured. The testing was done with a ramp rate of 10° C./min from 25° C. to 300° C.

### Sample Preparation:

An adhesive film was prepared from each of the three compositions by hand spreading each liquid adhesive comprising each of the three compositions respectively using a knife coater hand spreader between two liners to form a sandwich construction. The thickness of each coated adhesive between the liners was approximately 100-150 μm. The sandwich construction was then irradiated with a D-type bulb conveyor belt UV processor (Fusion UV Systems, Inc). In this way, the sandwich construction received about 1.8 J/cm2 of UV-A dosage.

The result obtained from the reaction process was graphed on a chart showing heat flow and peak temperature when each adhesive film was subjected to a particular period of time at 180° C. The integrated peak under the graph represents the total exotherm energy produced during the reaction. The exotherm profile is proportional to the extent of cure. Lower onset and/or peak temperature for the exotherm indicates that the monomer is polymerizing at the lower temperature which correlates with shorter gel time. Each individual composition is compared against the uncured stage to determine the time required to obtain a fully cured adhesive film. The results are shown in Tables 2, 3 and 4.

For the uncured adhesive for each composition, there are two curing peaks. Curing temperature 1 may be attributed to the curing of the epoxy resin system while curing temperature 2 may be attributed to the polymerization of the polymerizable acrylate system. It can be observed that for film adhesives which have been subjected to UV irradiation, curing temperature 2 is no longer detected. This may be because the acrylate system may have cured under the UV irradiation. For example, the curing of composition A-1 peaked at a temperature of about 165-170° C. A fully cured film was obtained after 20 minutes at 180° C. It would be understood that if a shorter time is required, a high temperature may be used for the curing.

From the results obtained in Tables 2 to 4, it can be seen that composition C had the fastest curing rate at 180° C. Accordingly, composition C was preferred compared to compositions A-1 and A-2.

TABLE 1
Table showing the components comprised in the different
compositions A-1, A-2 and C.

| | | % of chemical | | |
|---|---|---|---|---|
| | | comprised in | | |
| | | Composition | | |
| Function | Chemical (trade name) | A-1 | A-2 | C |
| Acrylate | 2-phenoxyethylacrylate esters | 28.0 | 28.0 | 11.57 |
| monomer | (SR339 (Sartomer)) | | | |
| | Ethoxylated bisphenol A | 3.4 | 3.4 | 3.82 |
| | diacrylate esters (SR602 | | | |
| | (Sartomer)) | | | |
| Epoxy | epichlorohydrin formaldehyde- | — | — | 43.85 |
| | phenol polymer epoxy (N740 | | | |
| | (DIC Corporation)) | | | |
| | Formaldehyde, polymer with | 23.0 | — | — |
| | (chloromethyl)oxirane and | | | |
| | methylphenol (Epon 164 | | | |
| | (Hexion) | | | |
| | EP49-23 (Adeka) - trade secret | — | 30.3 | — |
| Epoxy diluent | Glycidyl ether of cashew nutshell | 10.3 | — | 2.84 |
| | liquid (2513HP (Cardolite)) | | | |
| Photoinitiator | 2-benzyl-2-(dimethylamino)-1- | 0.6 | 0.6 | 0.35 |
| | (4-(4-morpholinyl)phenyl)-1- | | | |
| | butanone (Irgacure 369 (Ciba)) | | | |
| UV | 4-methylphenyl [4-(1- | — | — | — |
| photoinitiator | methylethyl)phenyl)iodonium | | | |
| | tetrakis(pentafluorophenyl)borate | | | |
| | (Rhodorsil 2074 (Rhodia)) | | | |
| Thermal filler | Aluminium oxide (Alumina | 13.8 | 13.8 | 29.41 |
| | (Durametal)) | | | |
| Coupling agent | 3-glycidoxypropyl | 0.4 | 0.4 | 0.47 |
| | trimethoxysilane (Silquest A-187 | | | |
| | (Momentive)) | | | |
| Curing agent | 2,4-diamino-6-[2′- | 2.0 | — | 2.52 |
| | methylimidazolyl-(1′)]-ethyl-s- | | | |
| | triazine (2MZ-A (Air Product)) | | | |
| | Modified amine - trade secret | — | 8.0 | — |
| | (EH4357S (Adeka)) | | | |
| Mixing | Vinylcaprolactam (N-vinyl | 6.9 | 3.9 | — |
| promoter | Caprolactam (BASF)) | | | |
| (promotes | | | | |
| mixing of the | | | | |
| epoxy and | | | | |
| acrylate | | | | |
| monomer) | | | | |
| Phenoxy | Phenol,4.4′-(1-methylethylidene) | 3.1 | 3.1 | 2.23 |
| | (PKHP200 (Inchem Phenoxy)) | | | |
| Toughening | Methacrylic, acrylic co-polymer | — | — | 2.94 |
| agent | methacrylic, acrylic co-polymer | | | |
| | (Dianal LP4100 (Mitsubishi | | | |
| | Rayon)) | | | |
| | P (BD/MMA/STY) (EXL 2691A | 8.5 | 8.5 | — |
| | (Rohm and Haas)) | | | |

TABLE 2
DSC results of Composition A-1.

| | Curing | Curing | | Curing | Curing | |
|---|---|---|---|---|---|---|
| | Temperature 1 | Energy 1 | % to | Temperature 2 | Energy 2 | Tg |
| Composition A-1 | (° C.) | (J/g) | Uncured | (° C.) | (J/g) | (° C.) |
| Uncured (w/o UV) | 168.03 | 63.99 | | 259.56 | 136.8 | NA |
| Cured film @ | 165.43 | 90.31 | | NA | NA | NA |
| UVA 1.848 J/cm² | | | | | | |
| (w/o Isotherm) | | | | | | |
| Cured film @ | 164.90 | 4.384 | 4.9% | NA | NA | NA |
| UVA 1.848 J/cm² | | | | | | |
| (Iso 180 C., 5 min) | | | | | | |
| Cured film @ | 166.71 | 1.096 | 1.2% | NA | NA | NA |
| UVA 1.848 J/cm² | | | | | | |
| (Iso 180 C., 10 min) | | | | | | |
| Cured film @ | 170.48 | 0.3058 | 0.3% | NA | NA | NA |
| UVA 1.848 J/cm² | | | | | | |
| (Iso 180 C., 15 min) | | | | | | |
| Cured film @ | Not Detected | Not Detected | | NA | NA | 11.75 |
| UVA 1.848 J/cm² | | | | | | |
| (Iso 180 C., 20 min) | | | | | | |

TABLE 3
DSC results of Composition A-2.

| | Curing | Curing | Curing | | | |
|---|---|---|---|---|---|---|
| | Temperature 1 | Energy 1 | Temperature 2 | Curing | % to | T g |
| Composition A-2 | (° C.) | (J/g) | (° C.) | Energy 2(J/g) | Uncured | (° C.) |
| Uncured (w/o UV) | 87.27 | 33.64 | 191.49 | 7.219 | | NA |
| SG EAS 1002 R | Not Detected | Not Detected | 190.6 | 2.365 | 33% | NA |
| (Iso 1080 C., 5 min) | | | | | | |
| SG EAS 1002 R | Not Detected | Not Detected | 182.91 | 0.7524 | 10% | NA |
| (Iso 1080 C., | | | | | | |
| 10 min) | | | | | | |
| SG EAS 1002 R | Not Detected | Not Detected | 181.42 | 0.4324 | 6% | NA |
| (Iso 1080 C., | | | | | | |
| 15 min) | | | | | | |
| SG EAS 1002 R | Not Detected | Not Detected | Not Detected | Not Detected | Not Detected | 2.57 |
| (Iso 1080 C., | | | | | | |
| 20 min) | | | | | | |

TABLE 4
DSC results of Composition C.

| | Curing | Curing | Curing | Curing | |
|---|---|---|---|---|---|
| | Temperature 1 | Energy 1 | Temperature 2 | Energy 2 | % to |
| Composition C | (° C.) | (J/g) | (° C.) | (J/g) | Uncured |
| Uncured (w/o UV) | 151.34 | 258.7 | 207.00 | 21.43 | |
| B-stage film (UVA | 145.79 | 147.4 | 251.58 | 4.308 | |
| dosage ~1.8 J/cm²) | | | | | |
| B-stage film (Iso | Not Detected | Not Detected | Not Detected | Not Detected | — |
| 180° C. for 5 min) | | | | | |
| B-stage film (Iso | Not Detected | Not Detected | Not Detected | Not Detected | — |
| 180° C. for 10 min) | | | | | |
| B-stage film (Iso | Not Detected | Not Detected | Not Detected | Not Detected | — |
| 180° C. for 15 min) | | | | | |
| B-stage film (Iso | Not Detected | Not Detected | Not Detected | Not Detected | — |
| 180° C. for 20 min) | | | | | |

### Peel Adhesion Test

A 90° peel adhesion test was used to measure the force required to peel a 35 μm thick 0.5″ width copper strip from an aluminium substrate. Compositions A-1, A-2 and C were used for this test. The adhesives comprising compositions A-1, A-2, and C, respectively, were applied onto an aluminium substrate followed by UV irradiation (1.5 J/cm²) of the coated adhesive.

The aluminium substrates were pre-heated at 200° C. for a minute and cooled at 25° C. for 15 seconds. The copper strip, which was preheated at 200° C. for 1.5-2 minutes, was then laminated onto the aluminium substrate via a roller laminator at 6.6 bar. The top and bottom temperature set for the roller was 100° C. each. The prepared samples were then placed in oven for curing at 200° C. and then taken out to cool for at least 30 minutes in room temperature prior to conducting the peel test.

The results obtained are shown in Table 5.

TABLE 5
Results of peel adhesion test.

| | Composition | | |
|---|---|---|---|
| | A-1 | A-2 | C |
| 90 degree peel adhesion/N | 6.2 | 18 | 15.8 |

Each of compositions A-1, A-2 and C contained different epoxies in different amounts, which results in the different peel adhesion strengths. For example, the peel adhesion strength of composition A-2 is higher due to the presence of the chelated modified epoxy in the composition since the chelated modified epoxy may act as an additional adhesion promoter. Although composition A-2 demonstrated the highest adhesion peel strength, the material formed from composition A-2 remained soft after curing. The material formed from composition C had comparable adhesion peel strength to composition A-2 while being relatively hard.

### Hardness Measurement

Hardness measurement of compositions A-1, A-2 and C was done based on a rigid ball penetration into a specimen casted to specific shape and thickness. The softer the material, the better is its conformability and embeddability properties and thus leading to a better thermal conductivity performance of the adhesive upon compression.

The results obtained are shown in Table 6.

TABLE 6
Results obtained from hardness measurements performed
on compositions A-1, A-2 and C.

| Hardness Test | A-1 | A-2 | C |
|---|---|---|---|
| After B-stage | Shore A 17 | Shore A 35 | Shore 00 30 |
| After C-stage | Shore D 35 | Shore A 43 | Shore D 52 |

It can be seen from the results obtained that composition C had the best conformability and compressibility among the compositions tested after B-stage. Composition C was also very hard after being fully cured. Accordingly, composition C satisfies the requirements for obtaining a good lamination between rigid substrates.

### Thermal Conductivity Test

Laminates of copper and aluminium were prepared by the process described under “Peel adhesion test”. The laminates were then cut into discs of 8 cm diameter and placed between two electrodes with a temperature gradient. The two electrodes were two polished metal surfaces of copper chrome. The temperature of the upper surface of each electrode was controlled while the lower surface was attached to a cooling heat sink. The temperature difference and the rate of hear transfer was measured and the thermal conductivity was calculated based on the measurements, as shown in Table 7.

TABLE 7
Results obtained from thermal conductivity test performed on composition A-1.

| | | | | | | | | | Impedance | Conductivity |
|---|---|---|---|---|---|---|---|---|---|---|
| | T | V | I | q | Heat Flux | T1 | T2 | ΔT | Uncorrected Z | Apparent k |
| Sample | (mm) | (V) | (A) | (W) | (W/cm2) | (° C.) | (° C.) | (° C.) | (° C.-cm²/W) | W/m-K |
| A-1 | 0.05 | 20 | 0.44 | 8.8 | 1.4 | 25.8 | 25.4 | 0.4 | 0.29 | 1.705 |
| A-1 | 0.05 | 20 | 0.44 | 8.8 | 1.4 | 24.9 | 24.6 | 0.3 | 0.21 | 2.273 |
| A-1 | 0.1 | 20 | 0.44 | 8.8 | 1.4 | 25.5 | 24.7 | 0.8 | 0.57 | 1.705 |

The results obtained show that composition A-1 may be used as a thermally conductive medium between two surfaces.

### Overlap Shear Strength Test

The test was performed by applying an adhesive of composition C between two aluminium substrates.

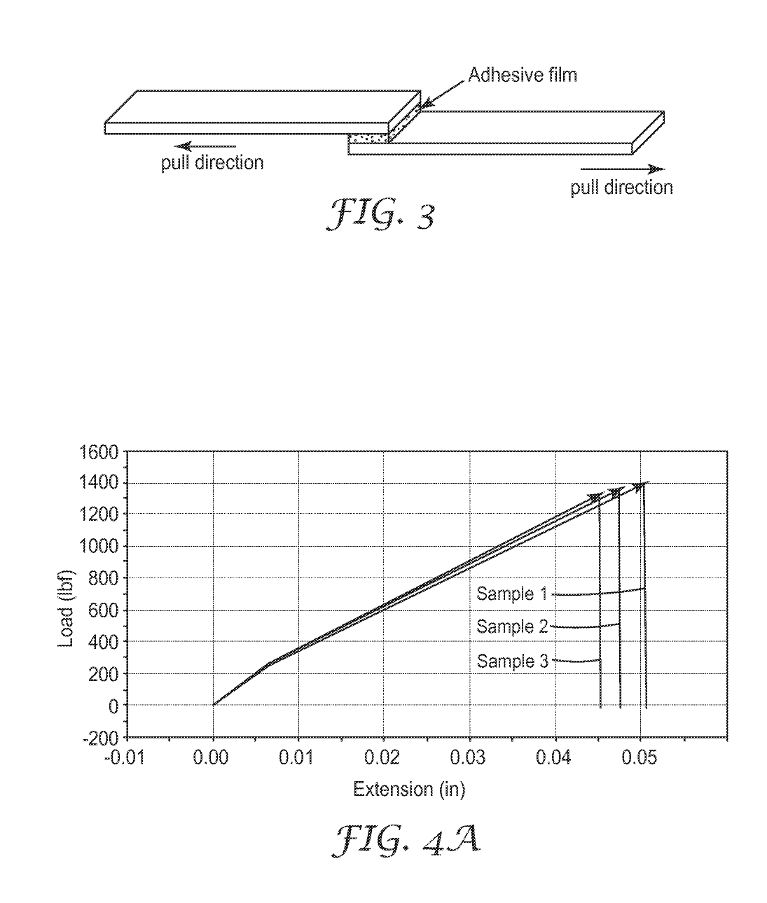

Composition C in liquid form was cast into a film between two fluoro-release liners (3M 5932 liners). In particular, the composition was coated using a six-inch wide knife coater station with the knife locked in position between the two liners to maintain a fixed gap. The gap was adjusted using a feeler gauge to a height of about 100 μm greater than the combined thickness of the two release liners. The composition was poured in the gap between the two release liners. The release liners were then pulled between the knife and the base on which the release liners were placed. The composition was then exposed to UV irradiation at UVA dosage of 1.5 J/cm² per side. An adhesive film thickness of about 100 μm was obtained. The set-up was as shown in FIG. 3.

The adhesive film was cut into a shape of 1″ by 0.5″ and one side of the liner was removed and placed on an abraded end of a 1″×4″ aluminium substrate. The substrate was pre-heated to 100° C. in an oven prior to attaching the adhesive onto the surface.

The substrates were clipped using two clips and then left in an oven at 220° C. for 5 to 10 minutes. Samples 2 to 4 were subjected to the same conditions to obtain the maximum shear stress for a sample subjected to these conditions in triplicate. The overlap shear strength was measured after the sample was sufficiently cooled to room temperature after the curing step.

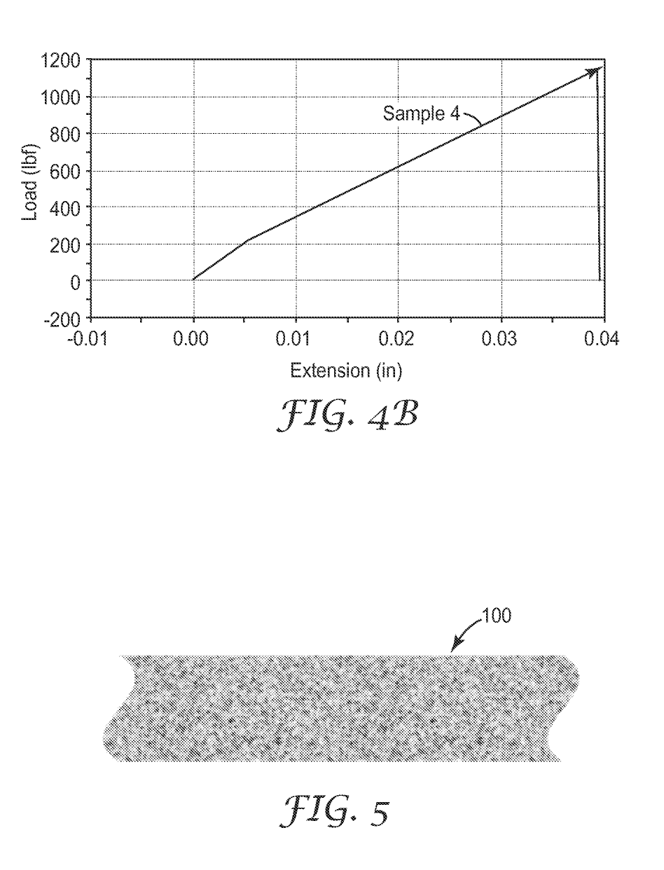

The results obtained are shown in Table 8 and FIGS. 4A and 4B.

TABLE 8
Table showing the maximum load and tensile shear
stress under different conditions

| | | Maximum shear stress |
|---|---|---|
| Sample | Maximum load (lbf) | (psi) |
| 1—220° C. 5 mins cured | 1407.98 | 2815.95 |
| 2—220° C. 10 mins cured | 1356.88 | 2713.76 |
| 3—220° C. 10 mins cured | 1330.05 | 2660.11 |
| 4—220° C. 10 mins cured | 1140.43 | 2280.85 |

In particular, the results show that composition C showed good overlap shear strength which is comparable to the strength of a structural adhesive.

Whilst the foregoing description has described exemplary embodiments, it will be understood by those skilled in the technology concerned that many variations may be made without departing from the present invention.

1. A circuit board comprising a first layer and a second layer of an impermeable material and a third layer of a bonding material, the bonding material comprising a polymerized polymer and a cured epoxy, wherein the first layer and the second layer are bonded to each other with the third layer, and wherein the bonding material has a sufficiently high viscosity such that the third layer does not exhibit substantial flow when heated to between 50° C. and 288° C.

2. The circuit board according to claim 1, wherein the bonding material has a viscosity of 10-10⁶ Pa/s when heated to between 50° C. and 288° C.

3. The circuit board according to claim 1, wherein the bonding material has a thermal resistance of 0.1 to 3° C.-cm²/W.

4. The circuit board according to claim 1, wherein the bonding material has a peel adhesion strength of at least 0.5 Kgf.

5. The circuit board according to claim 1, wherein the bonding material has a tensile shear stress of ≧1500 psi.

6. A composition for preparing a bonding material for use in a circuit board for bonding to a first layer and a second layer of an impermeable material comprising:
a polymerizable acrylate system; and
a curable epoxy resin system,
wherein the composition is photocurable to enable the acrylate system to polymerize without curing the epoxy resin system.

7. The composition according to claim 6, wherein the composition comprises:
10-80% by weight of a polymerizable acrylate system; and
20-80% by weight of a curable epoxy resin system.

8. The composition according to claim 6, further comprising a photoinitiator, a thermally conductive filler, or a combination thereof.

9. The composition according to claim 8, wherein the composition comprises 0.01-5% by weight of a photoinitiator.

10. The composition according to claim 8, wherein the composition comprises ≦70% by weight of a thermally conductive filler.

11. The composition according to claim 6, wherein the composition is thermally curable to enable the epoxy resin system to cross-link.

12. The composition according to claim 11, wherein the composition further comprises a thermal initiator.

13. The composition according to claim 12, wherein the composition comprises 2-5% by weight of a thermal initiator.

14. A tape, comprising a composition for bonding to at least a first layer, comprising:
a polymerizable acrylate system; and
a curable epoxy resin system, wherein the composition is photocurable to enable the acrylate system to polymerize without curing the epoxy resin system.

15. The tape according to claim 14, further comprising a backing layer disposed on at least one side of the composition.

16. The tape according to claim 15, wherein the backing layer comprises at least one of a glass, a polymer, a ceramic, and a metal.

17. The tape according to claim 14, wherein the composition has a thickness of about 6 μm to about 300 μm.

18. The tape according to claim 14, wherein the composition has a thickness and an opacity such that, when exposed to curing radiation, a center of the composition receives at least 25% of the curing radiation flux as compared to a surface directly exposed to the curing radiation.
